(19) United States
(12) Patent Application Publication
(10) Pub. No.: US 2026/0219851 A1
(43) Pub. Date: Jul. 30, 2026

(54) PROACTIVE AUTOMATED ANOMALY DETECTION AND CORRECTION OF GENERATIVE AI GENERATED CONTENT USING REFRESH TOKENS

(71) Applicant: Bank of America Corporation, Charlotte, NC (US)

(72) Inventors: Maharaj Mukherjee, Poughkeepsie, NY (US); Naga Vamsi Krishna Akkapeddi, Charlotte, NC (US); George Albero, Charlotte, NC (US)

(21) Appl. No.: 19/038,348

(22) Filed: Jan. 27, 2025

(51) Int. Cl. G06F 8/41

(52) U.S. Cl. CPC G06F 8/447

(57) ABSTRACT

A computing platform may generate a target software architecture comprising target software components. The computing platform may tokenize attributes of each target software component to produce target tokens. The computing platform may generate, using generative AI applications, AI generated software components. The computing platform may tokenize attributes of each AI generated software component to produce refresh tokens. The computing platform may compare the refresh tokens and the target tokens to identify anomalies. The computing platform may refine, based on the anomalies, the generative AI applications and update the AI generated software components. The computing platform may update the refresh tokens based on the updated AI generated software components. The computing platform may identify a match between the refresh tokens and the target tokens. Based on identifying the match, the computing platform may compile the updated AI generated software components, and deploy the software for execution.

### BACKGROUND

In some instances, a software development life cycle (SDLC) may be used to generate, test, and deploy software to a live environment. During the SDLC process, there may be scenarios where each application component uses a different technology. In some instances, generative artificial intelligence (AI) may be used to generate software code for each component, and may utilize existing custom libraries and/or applications, as well as vendor delivered libraries and/or applications for doing it.

The generated software for each component may cause integration issues, compatibility issues, and/or other issues. These issues may be detected in later phases of the SDLC. Furthermore, manual due diligence may be necessary to make sure generated software operates as expected, and manual correction of the corresponding components' software code may be required to address any anomalies. As a result, it may be difficult to ensure accuracy and effectiveness of software generated using generative AI applications.

### SUMMARY

Aspects of the disclosure provide effective, efficient, scalable, and convenient technical solutions that address and overcome the technical problems associated with the use of generative artificial intelligence in software generation. In accordance with one or more embodiments of the disclosure, a computing platform comprising at least one processor, a communication interface, and memory storing computer-readable instructions may generate a target software architecture comprising a plurality of target software components. The computing platform may tokenize attributes of each target software component to produce target tokens. The computing platform may generate, using a plurality of generative artificial intelligence (AI) applications, AI generated software components. The computing platform may tokenize attributes of each AI generated software component to produce refresh tokens. The computing platform may compare the refresh tokens and the target tokens to proactively identify anomalies between the plurality of target software components and the AI generated software components. The computing platform may refine, based on the anomalies, one or more of the plurality of generative AI applications. The computing platform may generate, using the one or more of the plurality of generative AI applications, updated AI generated software components. The computing platform may update the refresh tokens based on the updated AI generated software components. The computing platform may identify a match between the refresh tokens and the target tokens. Based on identifying the match, the computing platform may compile software based on the updated AI generated software components. The computing platform may deploy the software for execution.

In one or more instances, the generating the target software architecture may include applying one or more of: optical character recognition, natural language processing, natural language understanding, to identify, based on a software requirement document, the plurality of target software components. In one or more instances, producing the target tokens may include, for each of the plurality of target software components: 1) identifying component level details comprising one or more of: data elements, attributes, or metadata, and 2) generating, for the corresponding target software component, a corresponding target token.

In one or more examples, the computing platform may store the target tokens in a database table, and expose, via an application programming interface, the database table. In one or more examples, the plurality of generative AI applications include one or more of: different types of generative AI applications, different generative AI application versions, or generative AI applications associated with different vendors, and each of the plurality of generative AI applications may be associated with a different source.

In one or more instances, generating the refresh tokens may include, for each of the plurality of generative AI applications: 1) using an application specific plugin to analyze source code of a corresponding AI generated software component, wherein the analysis results in identification of component level details comprising one or more of: data elements, attributes, or metadata of the corresponding AI generated software component, and 2) generating, based on the component level details, a corresponding refresh token.

In one or more instances, each refresh token may be: 1) a customizable token leveraging open-source technology, 2) a reusable token, and 3) an updatable token, refreshed to include current component level details of a corresponding AI generated software component. In one or more instances, comparing the refresh tokens and the target tokens to proactively identify the anomalies between the plurality of target of software components and the AI generated software components may include: 1) accessing the refresh tokens and the target tokens; 2) mapping, based on metadata associated with the refresh tokens and the target tokens, each refresh token to a corresponding target token to produce token pairs; and 3) for each token pair, comparing the metadata of a corresponding refresh token and target token.

In one or more examples, comparing the metadata of the token pairs may include: 1) for a first token pair, identifying a complete match between metadata of the corresponding refresh and target tokens 2) for a second token pair, identifying a discrepancy between metadata of the corresponding refresh and target tokens, and 3) log, in a table, the discrepancy and a generative AI application associated with the target token of the second token pair. In one or more examples, refining the one or more of the plurality of generative AI applications may include: 1) sending, to the generative AI application associated with the target token of the second token pair and based on the logged discrepancy, feedback information; and 2) modifying, based on the feedback information, one or more parameters, features, or weights of the generative AI application associated with the target token of the second token pair.

In one or more instances, identifying the match between the refresh tokens and the target tokens comprises identifying, for all token pairs, that no discrepancies exist between component level details of the corresponding refresh tokens and target tokens. In one or more instances, the software may satisfy the target software architecture.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for performing proactive automated anomaly detection and correction of generative AI generated content using refresh tokens in accordance with one or more example embodiments.

FIGS. 2A-2D depict an illustrative event sequence for performing proactive automated anomaly detection and correction of generative AI generated content using refresh tokens in accordance with one or more example embodiments.

FIG. 3 depicts an illustrative method for performing proactive automated anomaly detection and correction of generative AI generated content using refresh tokens in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Described herein is a system for proactively detecting discrepancies in content (and specifically software components) generated using generative artificial intelligence (AI). The system may generate a target architecture diagram. For example, a custom model written in python may be used to read a requirement document and generate the target architecture diagram. In some instances, this may consist of several components that may tie together to become operative. The system may then dissect this target architecture. For example, the system may use the same custom model to identify the features of each component with component level details such as data elements, attributes, respective metadata, or the like, and may tokenize these features. These tokens may be saved in a database table, which may be exposed via an application programming interface (API).

Content may be generated using generative artificial intelligence. For example, different applications, modules, or sources may generate software for each component using generative AI. A python-based plugin at each source may be used to read the source code, and to identify the component level data elements with respective metadata. Refresh tokens may be used to represent the metadata of each source.

The system may then perform metadata-based mapping using refresh tokens. For example, a plugin may be used to call an API of the model, which may extract the contents of the source refresh tokens and the target architecture's component level tokens, and may perform the mapping between source component level data elements and target component data elements leveraging respective metadata.

The system may identify, based on the mapping, any discrepancies at an attribute level and may log them in a table. The system may then send feedback with the logged items in the table to the source application using an API. The generative AI engine may then read the feedback, re-generate the software component, and update the refresh tokens. This cycle may be repeated until the generated software component fits the target architecture.

These and other features are described in greater detail below.

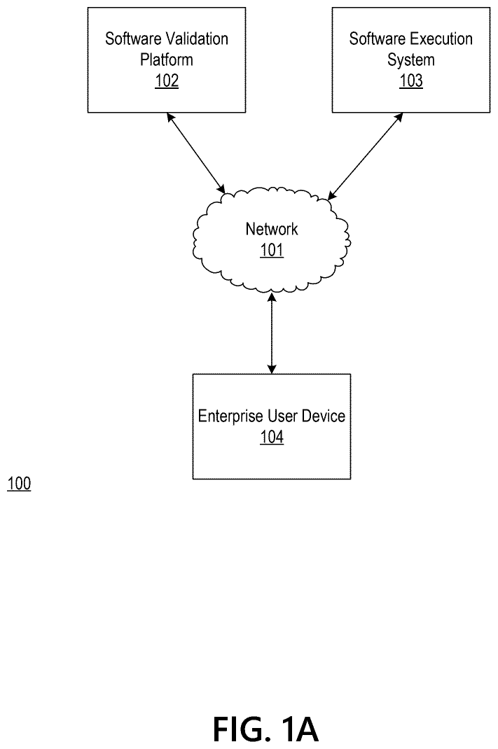

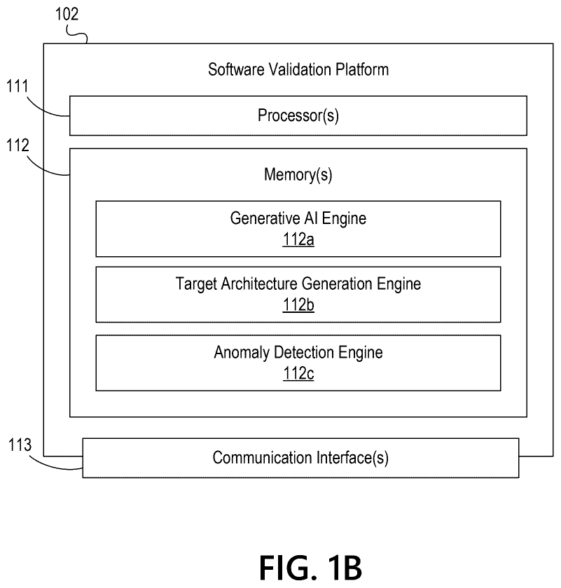

FIGS. 1A-1B depict an illustrative computing environment for performing proactive automated anomaly detection and correction of generative AI generated content using refresh tokens in accordance with one or more example embodiments. Referring to FIG. 1A, computing environment 100 may include one or more computer systems. For example, computing environment 100 may include software validation platform 102, software execution system 103, and enterprise user device 104.

Software validation platform 102 may include one or more computing devices (servers, server blades, or the like) and/or other computer components (e.g., processors, memories, communication interfaces, or the like). For example, the software validation platform 102 may be configured to produce, validate, refine, and/or otherwise deploy software for execution. For example, the software validation platform 102 may be configured to use artificial intelligence to perform anomaly detection for software components.

Software execution system 103 may be or include one or more devices (e.g., laptop computers, desktop computer, smartphones, tablets, and/or other devices) configured for use in executing the software produced by the software validation platform 102. In some instances, the software validation platform 102 may be configured to display one or more graphical user interfaces associated with execution of the software. For illustrative purposes in the event sequence described below, it may be assumed that any number of software execution system 103 may be included in the computing environment described herein.

Enterprise user device 104 may be or include one or more devices (e.g., laptop computers, desktop computer, smartphones, tablets, and/or other devices) configured for use submitting requests for software generation, or the like. For example, the enterprise user device 104 may be operated by an employee of an enterprise organization associated with the software validation platform 102. In some instances, the enterprise user device 104 may be configured to display one or more graphical user interfaces associated with analysis of the software, or the like.

Computing environment 100 also may include one or more networks, which may interconnect software validation platform 102, software execution system 103, enterprise user device 104. For example, computing environment 100 may include a network 101 (which may interconnect, e.g., software validation platform 102, software execution system 103, and enterprise user device 104).

In one or more arrangements, software validation platform 102, software execution system 103, and enterprise user device 104 may be any type of computing device capable of receiving a user interface, receiving input via the user interface, and communicating the received input to one or more other computing devices, and/or training, hosting, executing, and/or otherwise maintaining one or more artificial intelligence models. For example, software validation platform 102, software execution system 103, enterprise user device 104, and/or other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of software validation platform 102, software execution system 103, and enterprise user device 104 may, in some instances, be special-purpose computing devices configured to perform specific functions.

Referring to FIG. 1B, software validation platform 102 may include one or more processors 111, memory 112, and communication interface 113. A data bus may interconnect processor 111, memory 112, and communication interface 113. Communication interface 113 may be a network interface configured to support communication between software validation platform 102 and one or more networks (e.g., network 101, or the like). Memory 112 may include one or more program modules having instructions that when executed by processor 111 cause software validation platform 102 to perform one or more functions described herein and/or one or more databases that may store and/or otherwise maintain information which may be used by such program modules and/or processor 111. In some instances, the one or more program modules and/or databases may be stored by and/or maintained in different memory units of software validation platform 102 and/or by different computing devices that may form and/or otherwise make up software validation platform 102. For example, memory 112 may have, host, store, and/or include generative AI engine 112a, target architecture generation engine 112b, and anomaly detection engine 112c.

Generative AI engine 112a may be configured to train, host, apply, and/or otherwise maintain one or more artificial intelligence models for use in generating software. In some instances, the generative AI engine 112a may host a plurality of different artificial intelligence applications, which may, e.g., be different artificial intelligence models, different versions of such models, models provided by different vendors, or the like. Although depicted as a single engine within the software validation platform 102, in some instances, multiple different generative AI engines may be implemented (i.e., within the software validation platform 102 or across multiple different systems other than the software validation platform 102) without departing from the scope of the disclosure. In some instances, the generative AI engine 112a may be configured to tokenize attributes of the generated software components (e.g., using refresh tokens).

Target architecture generation engine 112b may be configured to provide a target software architecture based on a corresponding software requirement document. For example, the target architecture generation engine 112b may be configured to support one or more machine learning, optical character recognition, natural language processing, natural language understanding, and/or other techniques to produce such an architecture. The target architecture generation engine 112b may likewise be configured to tokenize attributes of software components of the architecture.

Anomaly detection engine 112c may be configured to compare features represented by the target tokens and the refresh tokens to identify anomalies between software components produced by the generative AI engine 112a and the target software architecture components. Where anomalies are identified, the anomaly detection engine 112c may be configured to provide feedback to the generative AI engine 112a, which may, e.g., update the generative AI applications based on the feedback.

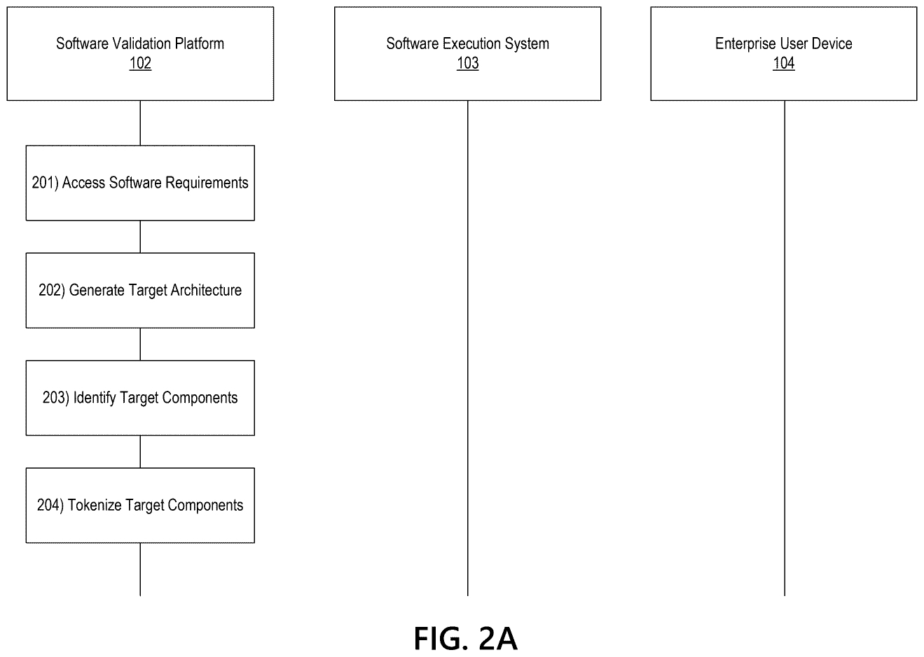

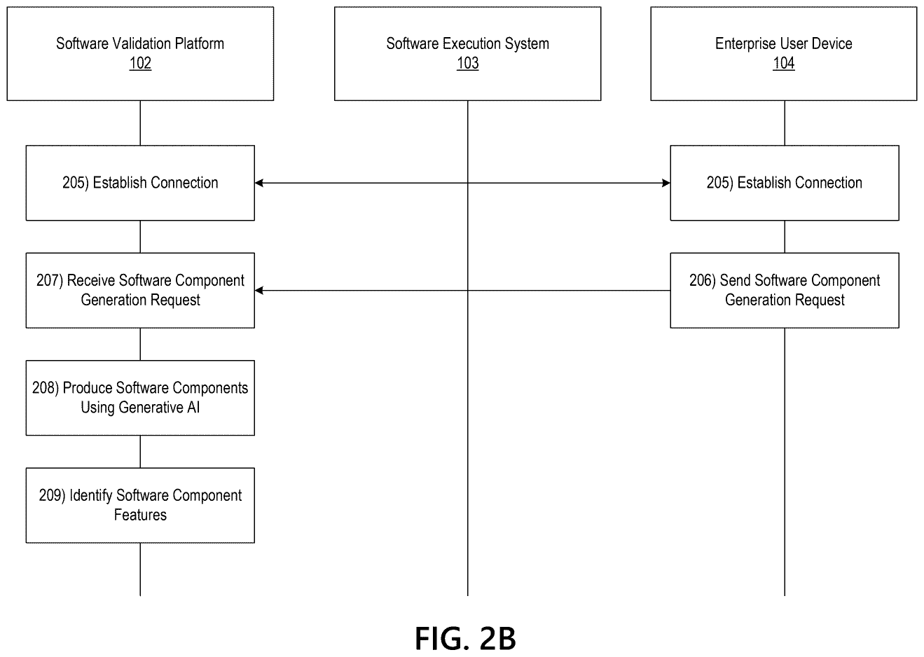

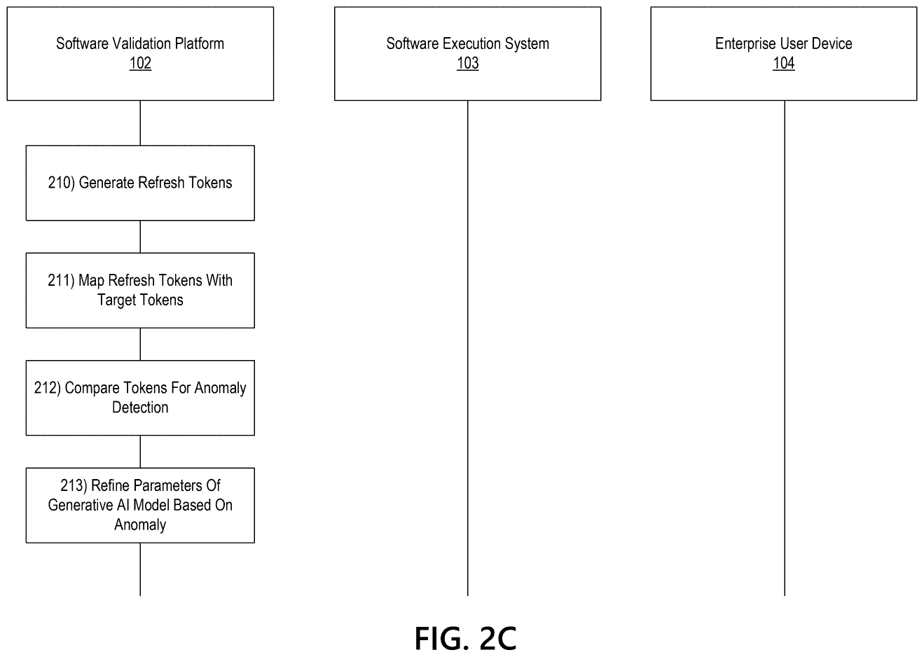

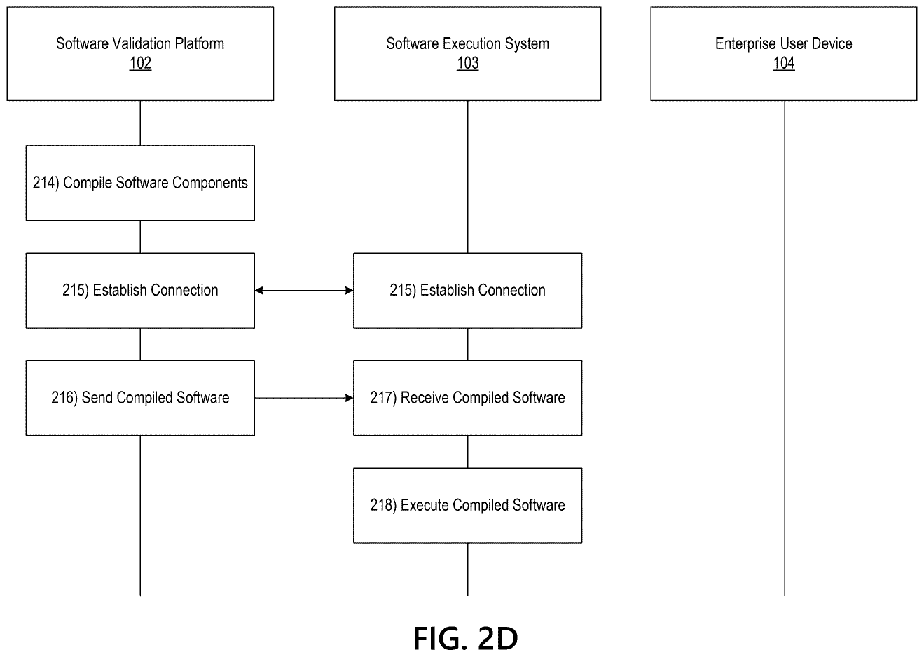

FIGS. 2A-2D depict an illustrative event sequence for performing proactive automated anomaly detection and correction of generative AI generated content using refresh tokens in accordance with one or more example embodiments. Referring to FIG. 2A, at step 201, the software validation platform 102 may access software requirements. For example, the software validation platform 102 may access a software requirement document and/or other document that may include one or more desired features for software to be produced. In some instances, the software validation platform 102 may access these requirements from a knowledge data base, based on a user request, and/or otherwise.

At step 202, the software validation platform 102 may generate a target architecture for the software based on the software requirement document accessed at step 201. For example, the software validation platform 102 may perform one or more of: optical character recognition (OCR), natural language processing (NLP), natural language understanding (NLU), and/or other techniques to extract, from the software requirement document, the desired features of the software. In some instances, the software validation platform 102 may apply a machine learning and/or other artificial intelligence model, which may, e.g., identify, based on the desired features, a plurality of action items to be completed by the software that, when executed, may produce a target architecture denoting the desired features, results, and/or other information of the target architecture. In some instances, this machine learning model may be a custom model written in a particular programming language, such as python, and configured to generate target architecture diagrams based on a given software requirement document.

At step 203, the software validation platform 102 may separate the target architecture, generated at step 202 into target components. For example, the software validation platform 102 may generate target components configured to trigger an electronic form relevant to a customer to collect anti-money laundering (AML) refresh, save an electronic form JSON and prepare a link to the electronic form, send the form to a customer and notify them accordingly, collect data from a customer and save the data as a document, compare customer provided AML data with in-house data and mark the changes, review the AML data sent by the customer and notify the review completion, and/or perform other functions.

At step 204, the software validation platform 102 may identify the features of each target component, such as component level data including data elements, attributes, metadata and/or other information of the target components. The software validation platform 102 may then tokenize these features, which may, e.g., result in a target token corresponding to each target component. In some instances, these target tokens may be stored in a database table, which may, e.g., be exposed via an application programming interface (API).

Referring to FIG. 2B, at step 205, enterprise user device 104 may establish a connection with software validation platform 102. For example, the enterprise user device 104 may establish a first wireless data connection with the software validation platform 102 to link the enterprise user device 104 with the software validation platform 102 (e.g., in preparation for requesting software component generation, or the like). In some instances, the enterprise user device 104 may identify whether a connection is already established with the software validation platform 102. If a connection is already established with the software validation platform 102, the enterprise user device 104 might not re-establish the connection. If a connection is not yet established with the software validation platform 102, the enterprise user device 104 may establish the first wireless data connection as described herein.

At step 206, the enterprise user device 104 may send a software component generation request to the software validation platform 102. For example, the enterprise user device 104 may send the software component generation request to the software validation platform 102 while the first wireless data connection is established. Although a single enterprise user device 104 is described, any number of enterprise user devices may be utilized to provide software component generation requests without departing from the scope of the disclosure. For example, in some instances, different enterprise user devices may be used to provide requests to generate different software components. In some instances, these software component generation requests may be and/or otherwise include prompts and/or other inputs that may be used by artificial intelligence applications to produce a software component.

At step 207, the software validation platform 102 may receive the software component generation request sent at step 206. For example, the software validation platform 102 may receive the software component generation request via the communication interface 113 and while the first wireless data connection is established. In some instances, the software validation platform 102 may receive a plurality of requests across a plurality of different artificial intelligence applications, which may, e.g., be hosted by the software validation platform 102 and/or other systems.

At step 208, the software validation platform 102 may generate a plurality of software components using a plurality of artificial intelligence applications. For example, based on the requests, prompts, and/or other inputs received at step 207, the software validation platform 102 may execute a plurality of generative artificial intelligence applications, which may, e.g., result in each generative artificial intelligence application producing a particular software component (which may, e.g., be a source code script). In these instances, each of the software components produced by the generative artificial may correspond to one of the target components of the target software architecture (e.g., the target components identified at step 203). More specifically, the goal/purpose of each of the generative artificial intelligence applications may be to generate a specific software component. In some instances, these different artificial intelligence applications may be different types and/or versions of the artificial intelligence models. Although the generation of these software components is depicted at the software validation platform 102, such generation may occur at a plurality of different sources, which may each host a particular artificial intelligence application, or the like.

At step 209, the software validation platform 102 may use a plugin to read the source code corresponding to each of the generated software components, and to identify component level data elements (e.g., attributes, metadata, and/or other information) with the respective metadata for each generated component. In some instances, this plugin may be a python based plugin. In instances where the artificial intelligence applications are hosted by sources different than the software validation platform 102, the plugin may be based at each source accordingly.

Referring to FIG. 2C, at step 210, the software validation platform 102 may generate refresh tokens representing the data elements, attributes, metadata, and/or other information identified at step 209. For example, the software validation platform 102 may generate customizable tokens that may use open source technology such as Java, C#, or the like. In some instances, these refresh tokens may be reusable tokens, and each time a given token is refreshed, the details of the corresponding token may be updated with the latest source metadata. For example, each refresh token may represent the component level data elements associated with a particular software component, generated by a particular artificial intelligence application.

At step 211, the software validation platform 102 may map the refresh tokens, generated at step 210 to the target tokens, generated at step 204. For example, the software validation platform 102 may extract contents of both sets of tokens, and may map between the source component level data elements and the target component data elements based on the underlying metadata. In doing so, the software validation platform 102 may identify token pairs, each including a target token and the corresponding refresh token.

At step 212, the software validation platform 102 may compare the tokens included in each pair (e.g., compare, in each pair, the target token with the refresh token). For any token pairs in which any discrepancies are identified, the software validation platform 102 may log these discrepancies in a table, and proceed to step 213. In contrast, for any token pairs in which no discrepancies are identified, the software validation platform 102 may proceed to step 214. In doing so, the software validation platform 102 may proactively and automatically identify any discrepancies between software components generated using one of the artificial intelligence applications and the corresponding target software components.

At step 213, the software validation platform 102 may generate feedback information based on the discrepancies identified at step 212, and may input this feedback information into the corresponding artificial intelligence applications to retrain, update, improve, and/or otherwise modify the corresponding artificial intelligence applications, which may, e.g., cause the corresponding artificial intelligence applications to continuously improve in their ability to generate software components. For example, the features, weightings, and/or other parameters of the corresponding artificial intelligence applications may be updated based on the feedback information.

As a particular example, a software requirement document may have been analyzed to produce a target architecture that includes six different target components. A target token may be generated for each of the six different target components based on their individual metadata, which may result in six target tokens. Meanwhile, six different generative AI applications may be applied in an attempt to produce these six software components (i.e., a first generative AI application used to produce a software component corresponding to the first target component, or the like). Once produced, a refresh token may be generated for each of the six generated software components, resulting in six refresh tokens. Subsequently, once the target tokens and the refresh tokens have been generated, their metadata may be used to establish token pairs, each matching a single target token with a single corresponding refresh token. Once the token pairs are established, for each individual token pair, the included refresh token may be compared with the target token. If no discrepancies are identified, it may be assumed that the generated software component, associated with the refresh token, accurately matches the target component represented by the corresponding target token. By such analysis, it may be assumed that the generated software component may sufficiently function along with other software components to produce the desired software.

In contrast, if any discrepancies or anomalies are identified, this information may be used to refine the generative AI application that produced the generated software component associated with the corresponding refresh token. For example, if the discrepancy is identified between the first target token and the first refresh token, the feedback information may be used to update the first generative AI application (i.e., which produced the first generated software component corresponding to the first refresh token).

In instances where discrepancies are identified in certain token pairs but not others, only generative AI applications associated with the anomalous token pairs may be updated using the respective feedback of their corresponding token pairs (i.e., the second generative AI application may be updated based only on the corresponding second token pair, the fourth generative AI application may be updated based only on the corresponding fourth token pair, or the like).

Once the respective generative AI applications have been updated based on the feedback, the software validation platform 102 may return to step 208 to reproduce the corresponding generated software components. In these instances, only generated software components for which the corresponding generative AI application is updated may be regenerated. For example, if a first generated software component is determined to be accurate (i.e., based on the token comparison described above), and thus no further updates are made to the corresponding generative AI application, the first generated software component might not be regenerated. Rather, if, for example, the second generative AI application was updated based on a token discrepancy, the second generative AI application may be used to reproduce the second generated software component. This may conserve processing resources by avoiding the regeneration of software components that are already sufficient for execution, processing, or other application. Once any generated software components have been reproduced, their corresponding refresh tokens may be updated as described above in step 210.

Referring to FIG. 2D, at step 214, the software validation platform 102 may compile the software components generated at step 208. For example, in some instances, this may include compiling software components all associated with token pairs experiencing no discrepancies or anomalies between their corresponding target and refresh tokens. In some instances, this may include compiling some software components originally generated without discrepancies or anomalies between their corresponding target and refresh tokens, along with other software components that may have been regenerated one or more times after their corresponding generative AI applications were updated based on feedback indicating discrepancies, anomalies, or the like in their corresponding target and refresh tokens. In compiling the generated software components, the software validation platform 102 may produce the desired software.

At step 215, the software validation platform 102 may establish a connection with the software execution system. For example, the software validation platform 102 may establish a second wireless data connection with the software execution system 103 to link the software validation platform 102 with the software execution system 103 (e.g., in preparation for sending compiled software). In some instances, the software validation platform 102 may identify whether a connection is already established with the software execution system 103. If a connection is already established with the software execution system 103, the software validation platform 102 might not re-establish the connection. If a connection is not yet established with the software execution system 103, the software validation platform 102 may establish the second wireless data connection as described herein.

At step 216, the software validation platform 102 may send the compiled software to the software execution system 103. For example, the software validation platform 102 may send the compiled software to the software execution system 103 via the communication interface and while the second wireless data connection is established. In some instances, the software validation platform 102 may also send one or more commands directing the software execution system 103 to execute the software, which may, e.g., cause the software execution system 103 to execute the software.

At step 217, the software execution system 103 may receive the compiled software sent at step 216. For example, the software execution system 103 may receive compiled software while the second wireless data connection is established. In some instances, the software execution system 103 may also receive the one or more commands directing the software execution system 103 to execute the software.

At step 218, based on or in response to the one or more commands directing the software execution system 103 to execute the software, the software execution system 103 may execute the software accordingly. In these instances, because the generated software components used to compile the desired software were proactively evaluated using the above described token comparison, the software execution system 103 might not experience run time errors with the software, despite the various software components being generated by different types/versions of generative AI applications, which may in some instances, be hosted and/or otherwise maintained by different sources.

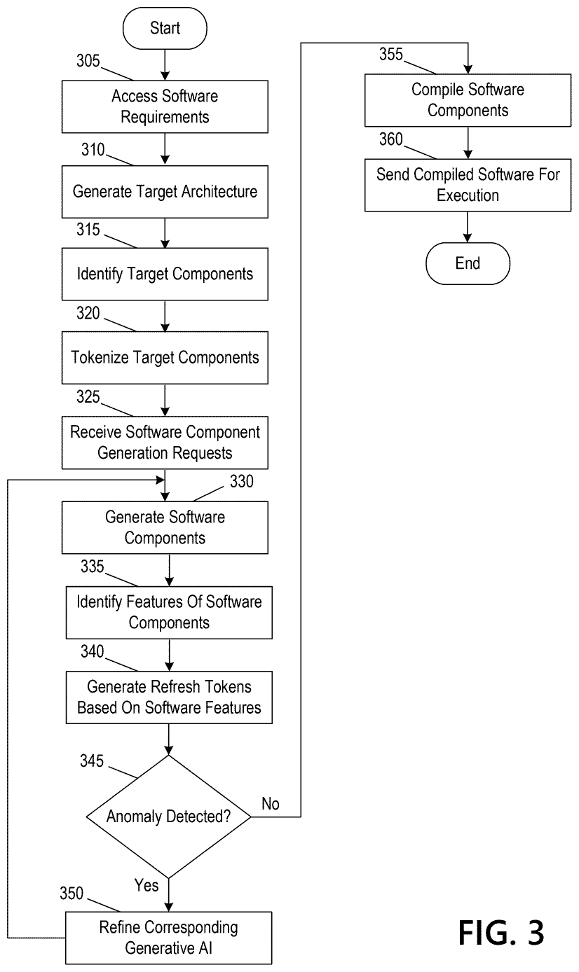

FIG. 3 depicts an illustrative method for performing proactive automated anomaly detection and correction of generative AI generated content using refresh tokens in accordance with one or more example embodiments. Referring to FIG. 3, at step 305, a computing platform comprising one or more processors, memory, and a communication interface may access software requirements. At step 310, the computing platform may generate a target software architecture based on the software requirements. At step 315, the computing platform may identify target software components within the target software architecture. At step 320, the computing platform may tokenize the target software components based on their metadata. At step 325, the computing platform may receive one or more software generation requests. At step 330, the computing platform may generate software components using generative AI applications. At step 335, the computing platform may identify features of the generated software components. At step 340, the computing platform may generate refresh tokens for each generated software component. At step 345, the computing platform may compare the target tokens with the refresh tokens to identify whether any pair of target/refresh tokens has discrepancies, anomalies, or the like between its corresponding target/refresh tokens. If any anomalies are detected, the computing platform may proceed to step 350 to generate feedback information based on the anomalies and to refine the corresponding generative AI application accordingly. The computing platform may then return to step 330 to regenerate the corresponding software components.

Returning to step 345, if no anomalies or discrepancies are identified, the computing platform may proceed to step 355. At step 355, the computing platform may compile the generated software components to produce the requested software. At step 360, the computing platform may send the compiled software for execution.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
generate a target software architecture comprising a plurality of target software components;
tokenize attributes of each target software component to produce target tokens;
generate, using a plurality of generative artificial intelligence (AI) applications, AI generated software components;
tokenize attributes of each AI generated software component to produce refresh tokens;
compare the refresh tokens and the target tokens to proactively identify anomalies between the plurality of target software components and the AI generated software components;
refine, based on the anomalies, one or more of the plurality of generative AI applications;
generate, using the one or more of the plurality of generative AI applications, updated AI generated software components;
update the refresh tokens based on the updated AI generated software components;
identify a match between the refresh tokens and the target tokens;
based on identifying the match, compile software based on the updated AI generated software components; and
deploy the software for execution.

2. The computing platform of claim 1, wherein generating the target software architecture comprises:
applying one or more of: optical character recognition, natural language processing, natural language understanding, to identify, based on a software requirement document, the plurality of target software components.

3. The computing platform of claim 1, wherein producing the target tokens comprises:
for each of the plurality of target software components,
identifying component level details comprising one or more of: data elements, attributes, or metadata, and
generating, for the corresponding target software component, a corresponding target token.

4. The computing platform of claim 1, wherein the memory stores additional computer-readable instructions that, when executed by the at least one processor, cause the computing platform to:
store the target tokens in a database table; and
expose, via an application programming interface, the database table.

5. The computing platform of claim 1, wherein the plurality of generative AI applications include one or more of: different types of generative AI applications, different generative AI application versions, or generative AI applications associated with different vendors, and wherein each of the plurality of generative AI applications is associated with a different source.

6. The computing platform of claim 1, wherein generating the refresh tokens comprises:
for each of the plurality of generative AI applications:
using an application specific plugin to analyze source code of a corresponding AI generated software component, wherein the analysis results in identification of component level details comprising one or more of: data elements, attributes, or metadata of the corresponding AI generated software component, and
generating, based on the component level details, a corresponding refresh token.

7. The computing platform of claim 1, wherein each refresh token:
comprises a customizable token leveraging open-source technology,
comprises a reusable token, and
comprises an updatable token, refreshed to include current component level details of a corresponding AI generated software component.

8. The computing platform of claim 1, wherein comparing the refresh tokens and the target tokens to proactively identify the anomalies between the plurality of target of software components and the AI generated software components comprises:
accessing the refresh tokens and the target tokens;
mapping, based on metadata associated with the refresh tokens and the target tokens, each refresh token to a corresponding target token to produce token pairs; and
for each token pair, comparing the metadata of a corresponding refresh token and target token.

9. The computing platform of claim 8, wherein comparing the metadata of the token pairs comprises:
for a first token pair, identifying a complete match between metadata of the corresponding refresh and target tokens;
for a second token pair, identifying a discrepancy between metadata of the corresponding refresh and target tokens; and
log, in a table, the discrepancy and a generative AI application associated with the target token of the second token pair.

10. The computing platform of claim 9, wherein refining the one or more of the plurality of generative AI applications comprises:
sending, to the generative AI application associated with the target token of the second token pair and based on the logged discrepancy, feedback information; and
modifying, based on the feedback information, one or more parameters, features, or weights of the generative AI application associated with the target token of the second token pair.

11. The computing platform of claim 1, wherein identifying the match between the refresh tokens and the target tokens comprises identifying, for all token pairs, that no discrepancies exist between component level details of the corresponding refresh tokens and target tokens.

12. The computing platform of claim 1, wherein the software satisfies the target software architecture.

13. A method comprising:
at a computing platform comprising at least one processor, a communication interface, and memory:
generating a target software architecture comprising a plurality of target software components;
tokenizing attributes of each target software component to produce target tokens;
generating, using a plurality of generative artificial intelligence (AI) applications, AI generated software components;
tokenizing attributes of each AI generated software component to produce refresh tokens;
comparing the refresh tokens and the target tokens to proactively identify anomalies between the plurality of target software components and the AI generated software components;
refining, based on the anomalies, one or more of the plurality of generative AI applications;
generating, using the one or more of the plurality of generative AI applications, updated AI generated software components;
updating the refresh tokens based on the updated AI generated software components;
identifying a match between the refresh tokens and the target tokens;
based on identifying the match, compiling software based on the updated AI generated software components; and
deploying the software for execution.

14. The method of claim 13, wherein generating the target software architecture comprises:
applying one or more of: optical character recognition, natural language processing, natural language understanding, to identify, based on a software requirement document, the plurality of target software components.

15. The method of claim 13, wherein producing the target tokens comprises:
for each of the plurality of target software components,
identifying component level details comprising one or more of: data elements, attributes, or metadata, and
generating, for the corresponding target software component, a corresponding target token.

16. The method of claim 13, further comprising:
storing the target tokens in a database table; and
exposing, via an application programming interface, the database table.

17. The method of claim 13, wherein the plurality of generative AI applications include one or more of: different types of generative AI applications, different generative AI application versions, or generative AI applications associated with different vendors, and wherein each of the plurality of generative AI applications is associated with a different source.

18. The method of claim 13, wherein generating the refresh tokens comprises:
for each of the plurality of generative AI applications:
using an application specific plugin to analyze source code of a corresponding AI generated software component, wherein the analysis results in identification of component level details comprising one or more of: data elements, attributes, or metadata of the corresponding AI generated software component, and
generating, based on the component level details, a corresponding refresh token.

19. The method of claim 13, wherein each refresh token:
comprises a customizable token leveraging open-source technology,
comprises a reusable token, and
comprises an updatable token, refreshed to include current component level details of a corresponding AI generated software component.

20. One or more non-transitory computer-readable media storing instructions that, when executed by a computing platform comprising at least one processor, a communication interface, and memory, cause the computing platform to:
generate a target software architecture comprising a plurality of target software components;
tokenize attributes of each target software component to produce target tokens;
generate, using a plurality of generative artificial intelligence (AI) applications, AI generated software components;
tokenize attributes of each AI generated software component to produce refresh tokens;
compare the refresh tokens and the target tokens to proactively identify anomalies between the plurality of target software components and the AI generated software components;
refine, based on the anomalies, one or more of the plurality of generative AI applications;
generate, using the one or more of the plurality of generative AI applications, updated AI generated software components;
update the refresh tokens based on the updated AI generated software components;
identify a match between the refresh tokens and the target tokens;
based on identifying the match, compile software based on the updated AI generated software components; and
deploy the software for execution.
